(19) United States
(12) Patent Application Publication
(10) Pub. No.: US 2016/0179461 A1
(43) Pub. Date: Jun. 23, 2016

(54) TACTILE INPUT PRODUCED SOUND BASED USER INTERFACE

(71) Applicant: Microsoft Technology Licensing, LLC, Redmond, WA (US)

(72) Inventor: Edgar Leon, San Diego, CA (US)

(21) Appl. No.: 14/574,331

(22) Filed: Dec. 17, 2014

(51) Int. Cl. G06F 3/16; G06F 1/16

(52) U.S. Cl. CPC G06F 3/167; G06F 1/1684

(57) ABSTRACT

A device for providing sound-based user interface is described. The device can include a housing including at least front and back surfaces. The device can include at least two microphones disposed inside the housing with the at least two microphones to receive sound data associated with a tactile motion input on one of the at least front and back surfaces of the housing. The device can include a sound processor disposed inside the housing and communicatively linked with the at least two microphones. The sound processor is able to compare the sound data received at each of the at least two microphones to determine a direction of the tactile motion input. A host processor is disposed inside the housing and communicatively linked to the sound processor. The host processor can control a command of the device based at least in part on the determined direction of the tactile motion input.

### TECHNICAL FIELD

This patent document relates to sound-based user interface.

### BACKGROUND

Various electronic user devices including mobile devices such as a smartphone and a tablet include user interfaces for a user to provide input commands or information and to receive the device outputs. Examples of user interfaces existing on the electronic devices include a touchscreen, and a physical button.

### SUMMARY

This patent document describes technology for providing a user interface in electronic devices based on a property of sound data associated with a tactile motion input.

The described technology uses preexisting two or more microphones included in a mobile device such as a smartphone. For example, a smartphone can include at least two preexisting microelectromechanical systems (MEMS) microphones for performing noise cancellation. The microphones tend to be located on the back surface of the smartphone for the purpose of performing the noise cancellation functionality. The described technology can leverage the preexisting microphones to detect sound signals or data associated with tactile motion inputs, such as scratches on the back surface of the device, analyze the detected sound signals or data to identify a direction of the tactile motion input that cause the detected sound signals or data. The identified direction of the tactile motion input can be used as a unique user input to perform one or more commands on the smartphone including navigate a user interface on the smartphone. The tactile motion input can include making scratches on the back surface of the smartphone.

For example, light scratches on the back surface of the phone are detected and recorded by each microphone. An onboard sound processor can use an algorithm to analyze a property of the recorded sound data including the sound intensity and sound wave-form. The sound processor can compare the one or more properties, such as the sound intensity of the sound signals from each different microphone to determine the general vector direction of the scratch motion input, and a command on the smartphone can be controlled based on the determined general vector direction. For example, the smartphone screen can be scrolled accordingly to match the resulting vector. For example, a scratch origination on the upper side of the back cover, and moving down, can be used to scroll the screen down, and vice versa.

In another aspect, the described technology can be extended to include use of an application programming interface (API) to pre-map various tactile motion inputs to various command operations associated with different applications including integrating into games or other applications. For example, scratching the back surface of the smartphone can trigger a game character to or avatar to perform an action, such as speaking, moving, etc.

### BRIEF DESCRIPTION OF THE DRAWINGS

FIGS. 1A and 1B are block diagrams showing an exemplary device for implementing a user interface based on a tactile motion input induced sound characteristic.

FIG. 2 is a diagram showing an exemplary relationship between a tactile motion input induced sound characteristic and movement of tactile motion.

FIG. 3 is a process flow diagram showing an exemplary process flow for implementing a user interface based on a tactile motion input induced sound characteristic.

FIGS. 4A and 4B are block diagrams showing an exemplary device for mapping a tactile motion input induced sound characteristic to a command on the device using an API.

### DETAILED DESCRIPTION

Electronic devices including mobile devices, such as a smartphone and a tablet computer, are equipped with various user input mechanisms including a touch screen, voice activated commands, or physical buttons and keys. Through the various user input mechanisms, the user can provide input that controls one or more commands on an electronic device. The technology described in this patent document provides for a distinct user interface based on tactile motion input induced sound characteristics.

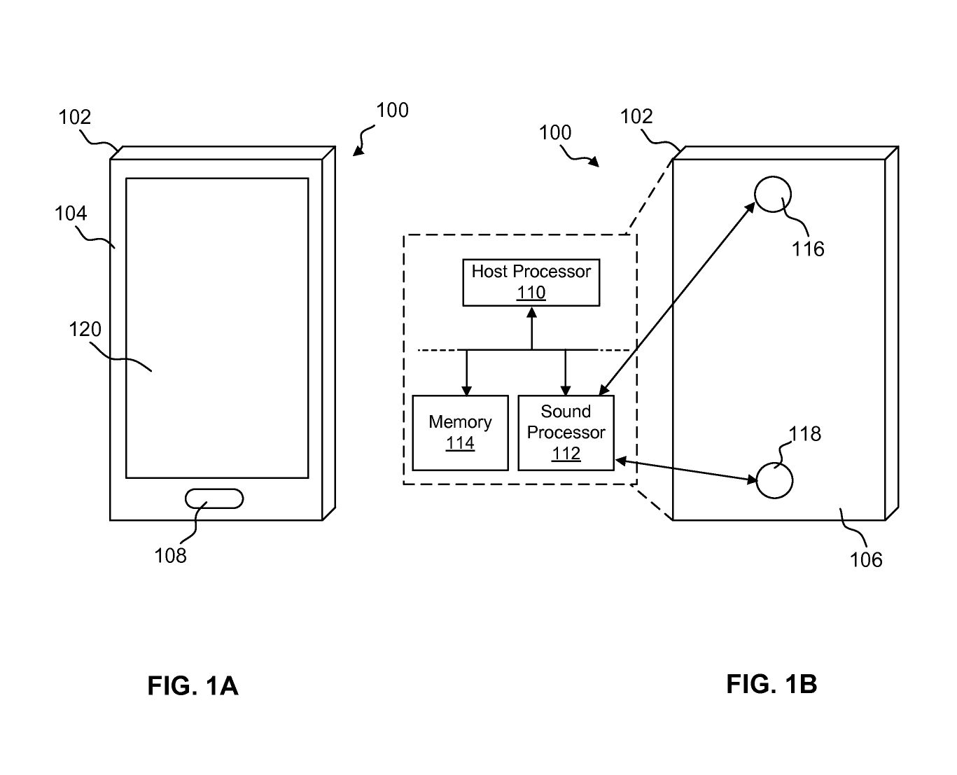

FIGS. 1A and 1B are block diagrams showing an exemplary device for implementing a user interface based on a tactile motion input induced sound characteristic. The device as shown in FIGS. 1A and 1B is a smart phone but the described technology can be implemented in various electronic user devices including various types of hand-held or mobile devices such as a tablet computer, a laptop, a netbook, a hybrid of a tablet and a notebook, a e-reader, and other electronic devices that includes two or more microphones. The device 100 includes a housing 102 that includes at least front 104 and back 106 surfaces. The housing 102 can have additional surfaces such as one or more side surfaces, a top surface and a bottom surface depending at least on the shape and form factor of the device 100. The described technology uses two or more different microphones at different locations as sound sensors to detect sound signals generated by a tactile motion by the user such as scratching a surface and uses a comparison algorithm in processing the detected sounds signals from the different microphones to extract the direction of the tactile motion. The direction of the tactile motion input can be used to form user commands to be carried out by the device based on a pre-determined mapping between tactile motion inputs and user commands. In implementations, the disclosed technology can be agnostic or independent of the texture of each surface. For example, an implementation of the disclosed technology is free from any reliance on sound properties associated with how the sound is generated, such as a sound property or characteristic in connection with a surface texture pattern. Notably, the described technology is applicable for surfaces having originally manufactured surface textures designed by device makers without considering the use of the surface for sound effects, or a non-specialized surface textures that are purely designed for achieving certain aesthetic appearance appeals, certain pleasing touch feelings or impressions other touch-based or visual effects from the surface textures.

As shown in FIG. 1A, the device 100 can include one or more existing user input mechanisms such as a touch screen 120 and a physical button 108. In addition, to the existing user input mechanisms, the device 100 includes at least two microphones 116 and 118 disposed inside the housing 102 as shown in FIG. 1B. The at least two microphones 116 and 118 have original functionalities to receive sound input and to perform background noise cancellation to enhance the audio quality of the device 100. While the microphones 116 and 118 can be disposed anywhere on the device 100, for performing at least the sound input reception and noise cancellation, the microphones 116 and 118 tend to be disposed to be exposed through the back surface 106 of the device 100.

Using the described technology, the microphones 116 and 118 is able to receive sound data associated with a tactile motion input on one of the at least front 104 and back 106 surfaces of the housing 102. For example, the tactile motion input can include a scratching motion on the back surface 106 of the device 100. One exemplary advantage of using the tactile motion input on the back surface 106 is the ability to remove the user's fingers away from the touchscreen 120. When a user input is received through the touch screen, the user's fingers and hands are in the field of view of the user and thus may block certain portions of the touchscreen 120, which can be disruptive to the user experience. In contrast, using a tactile motion input such as a scratch on the back surface 106 of the device 100 will remove the visual barriers from the field of view of the user.

The device 100 can include a sound processor 112 disposed inside the housing 102 and communicatively linked with the at least two microphones 116 and 118 to receive the sound data associated with the tactile motion input detected by the microphones 116 and 118. The sound processor 112 is able to compare the sound data received at each of the at least two microphones 116 and 118 to determine a direction of the tactile motion input. The device 100 includes a host processor 110 disposed inside the housing 102 and communicatively linked to the sound processor 112. The host processor 110 can control a command of the device 100 based at least in part on the determined direction of the tactile motion input.

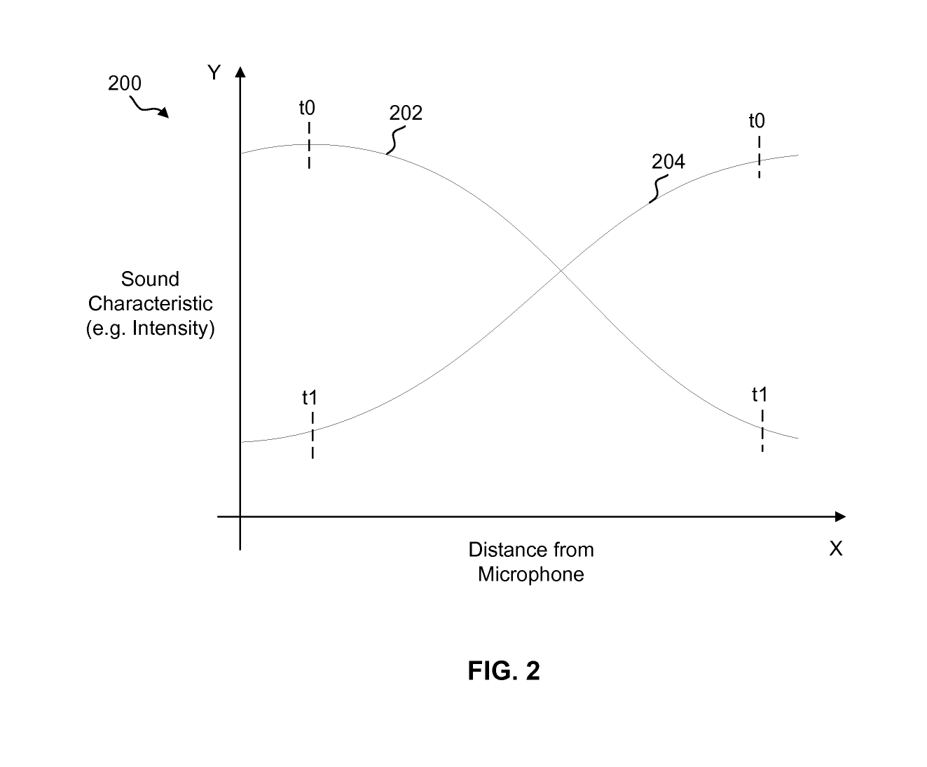

FIG. 2 is a diagram showing an exemplary relationship 200 between a tactile motion input induced sound characteristic and movement of tactile motion with respect to the locations of the microphones 116 and 118. The X-axis represents a movement of the tactile motion input in terms of a distance of the movement from the initial tactile motion to the final tactile motion with respect to the location of each microphone. The Y-axis represents an exemplary sound characteristic, such as sound intensity. Sound profile 202 represent a relationship of the sound intensity associated with the tactile motion input as captured or detected by microphone 116. Sound profile 204 represents a relationship of the sound intensity associated with the tactile motion input as captured or detected by microphone 118. Referring back to FIG. 1B, the two microphones 116 and 118 are disposed at opposite ends of the device 100. As described previously, this orientation of the microphones 116 and 118 may be due to the noise cancellation functionality. However, as previous described, the two microphones 116 and 118 can be disposed at different locations with respect to each other on the device 100.

In one example, a scratch motion input can be initiated at time (t0) at a location on the back surface 106 of the device 100 closer to the microphone 116 positioned closer to the top of the device 100. The scratch motion input can end at a location on the back surface 106 of the device 100 closer to the microphone 118 positioned closer to the bottom of the device 100. The sound profiles 202 and 204 show that at time (t0), the scratch motion input is closer to microphone 116 than the microphone 118. Similarly, at time (t0) the sound intensity of the sound data captured at the microphone 116 is at a level higher than the sound intensity of the sound data captured at the microphone 118. At time (t1), the sound intensity of the sound data captured at the microphone 116 is at a level lower than the sound intensity of the sound data captured at the microphone 118. Thus, the sound intensity of the sound data captured or detected at microphones 116 and 118 is dependent on the distance from the respective microphones 116 and 118. As the scratch motion is moved further away from a particular microphone, the sound intensity is reduced. The sound waveform of the sound profiles 202 and 204 shown in FIG. 2 is presented as an illustrative example only and the actual sound waveform can have different shapes.

The sound profiles 202 and 204 that represent the relationship between the sound characteristic (e.g., sound intensity) and the distance of the tactile movement on a surface of the device 100 that induced the sound data captured by the microphones 116 and 118 are processed by the sound process 112 to identify a direction of the tactile motion input. Identifying the direction of the tactile motion input based on the analysis of the sound profiles 202 and 204 can be performed using various techniques. In one technique, the at least two microphones 116 and 118 can receive the sound data over a predetermined period of time (e.g., from t0 through t1). The received sound data for the predetermined period of time can produce sound profiles such as sound profiles 202 and 204. The two sound profiles 202 and 204 can be compared over the predetermined period of time to identify the direction of the tactile motion input. One example of the sound profile comparison is to obtain a difference in the sound intensity of the two sound profiles throughout the entire predetermined period. Thus, the sound processor 112 can compare the sound data received at each of the at least two microphones 116 and 118 over the predetermined period of time to determine the direction of the tactile motion input including processing the sound data received over the predetermined period of time to detect a change in a property or characteristic of the sound data over the predetermined period of time, and comparing the change in the property or characteristic of the sound data over the predetermined period of time. The change in the property or characteristic of the sound data can include a change in intensity of the sound data over the predetermined period of time. The change in the property of the sound data can includes a change in waveform of the sound data over the predetermined period of time.

In another exemplary technique, the sound processor 112 can compare the sound data received at each of the at least two microphones 116 and 118 at two or more discrete time points to determine the direction of the tactile motion input. When sound data are captured over two or more discrete time points, a simple amplitude change along the discrete time points is determined and the sound waveform may not be used. The sound processor 112 can determine the differences in the sound intensity at each of the discrete time points to identify the direction of the sound data received due to the tactile motion input.

The sound processor 112 can perform additional sound data processing to enhance the identification of the direction of the tactile motion input. For example, the sound processor can communicate with the microphones 116 and 118 to perform background noise cancellation when comparing the sound data received at each of the at least two microphones 116 and 118 to determine the direction of the tactile motion input. Removing the background noise can enhance the comparison of the sound data received at each of the at least two microphones 116 and 118.

In addition, the sound processor 112 is able to compare the sound data detected at the microphones 116 and 118 independent of the texture of the surface on which the tactile motion input is received. Because the described technology provides for the sound processor 112 to perform a simple sound intensity comparison, the sound processor can compare the sound data received at each of the at least two microphones independent of a surface texture-based sound model to determine the direction of the tactile motion input. Thus, the described technology is applicable for surfaces with a originally manufactured or non-specialized texture.

The tactile motion input can include scratches to the back surface of the device or other tactile motions that can create sound data associated with the tactile motion input. Other examples of tactile motion input can include a sliding movement and a tapping movement.

The at least two microphones 116 and 118 can include microelectromechanical systems (MEMS) microphones or other microphones in the device 100 capable of detecting tactile motion input on a surface of the device. In addition, the device 100 can include more than two microphones and is configured to identify the direction of the tactile motion input can be enhanced as the number of the microphones are increased. Notably, the described technology can be used to identify the direction of the tactile motion by using only the existing microphones in the device 100 without needing to add microphones beyond the existing ones.

The host processor 110 can communicate with the sound processor to control a command of the device using the identified direction of the tactile motion input. The command of the device controlled using the identified direction of the tactile motion input can include a command to navigate a user interface of the device including scrolling, panning, cursor movement, user interface object (e.g., virtual button, tab or menu) selection, zooming in and out, and text or image selection and highlighting. In addition, the command of the device controlled using the identified direction of the tactile motion input can include a command to control any number of functions in an application running on the device 100 including a word processor, a calendar, an email application, a web browser, and a game among others.

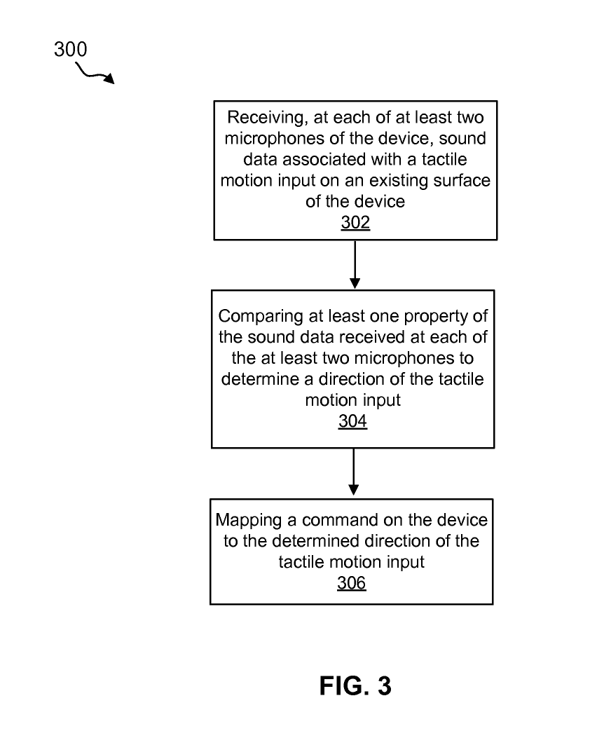

FIG. 3 is a process flow diagram showing an exemplary method 300 for implementing a user interface based on a tactile motion input induced sound characteristic. A method of providing sound-based user interface on a device is described. The method 300 includes receiving, at each of at least two microphones of the device, sound data associated with a tactile motion input on an existing surface of the device (302). The method includes comparing at least one property of the sound data received at each of the at least two microphones to determine a direction of the tactile motion input (304). The method can include mapping a command on the device to the determined direction of the tactile motion input (304).

As described above, the at least one property of the sound data compared can include sound intensity and/or sound waveform. In addition, receiving the sound data can include receiving the sound data at two or more discrete time points, such as a first time point and a second time point. Then the at least one sound property received at the two or more discrete time points can be compared to identify a direction of the tactile motion input received on at least on surface of the device 100. The comparison performed can include determining a change in the at least one property of the sound data received at the first time point and the second time point. The at least one property of the sound data can include an intensity of the sound data and/or a waveform of the sound data received at each of the microphones 116 and 118. The method 300 can include performing background noise cancellation when comparing the at least one property of the sound data received at each of the at least two microphones to determine the direction of the tactile motion input. Performing background noise cancellation can enhance the comparison and thus the identification of the direction of the tactile motion input. In addition, comparing the at least one property of the sound data received at each of the at least two microphones can be performed independent of a surface texture-based sound model to determine the direction of the tactile motion input. The described technology is not dependent on a specialized texture of the surface and thus, a texture-based modeling of the sound data is not performed before comparing the sound data received at each of the microphones 116 and 118.

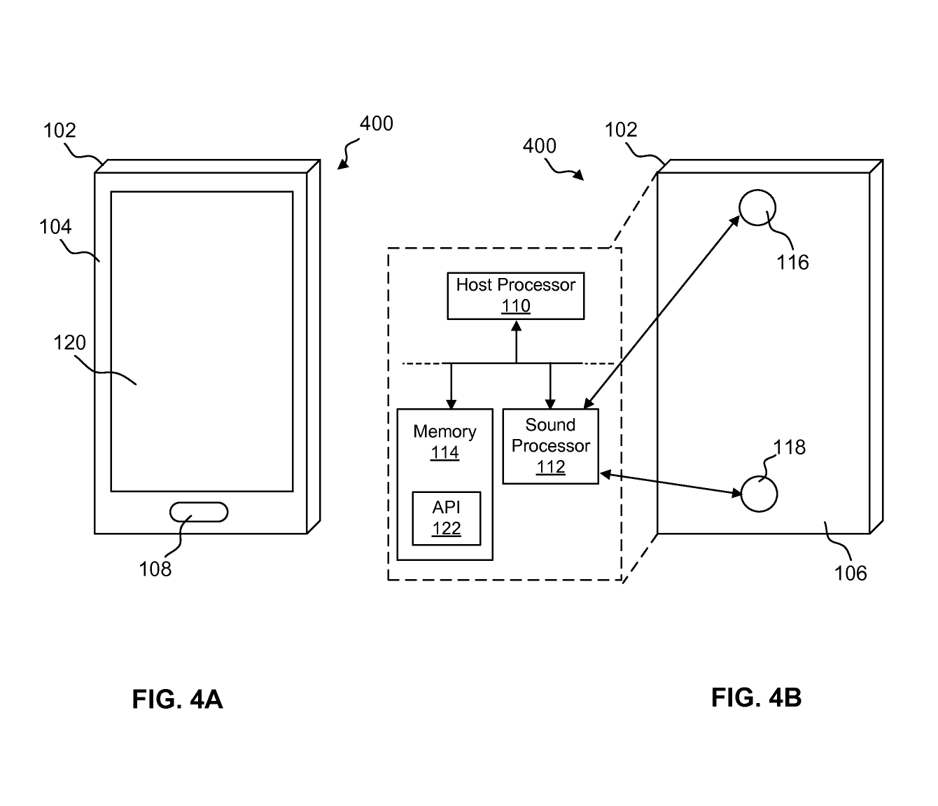

FIGS. 4A and 4B are block diagrams showing an exemplary device 400 for mapping a tactile motion input induced sound characteristic to a command on the device using an API. The device 400 shown in FIGS. 4A and 4B is substantially similar to the device 100 shown in FIGS. 1A and 1B with an addition of an API 122 used to map the identified direction of the tactile motion data to a specific command on the device 100. The device includes a housing 102 including at least front 104 and back 106 surfaces having an originally manufactured or a non-specialized texture. The device 400 includes at least two microphones 116 and 118 disposed inside the housing 102. The at least two microphones 116 and 118 can receive sound data associated with a tactile motion input on one of the at least front 104 and back 106 surfaces of the housing. The device 400 includes a sound processor 112 disposed inside the housing 102 and communicatively linked with the at least two microphones 116 and 118, the sound processor 112 can compare at least one property of the sound data received at each of the at least two microphones 116 and 118 to determine a direction of the tactile motion input. The device 400 can include a host processor 110 disposed inside the housing 102 and communicatively linked to the sound processor 112. The host processor 110 can operate an application programming interface (API) 122 that maps a command of the device 400 to the identified direction of the tactile motion input and use the mapped command to control an application running on the device. The API 122 can be at least temporarily stored in memory 114. The API 122 can be used to pre-map various directions of tactile motions inputs to various commands on the device 400, and the pre-mapping can be performed to provide different commands for different applications running on the device 400. Examples of applications running on the device can include a game, a web browser, a word processor, a calendar, an email application, a contacts list, among others.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A device for providing sound-based user interface, the device comprising:
a housing including at least front and back surfaces;
at least two microphones disposed inside the housing, the at least two microphones configured to receive sound data associated with a tactile motion input on one of the at least front and back surfaces of the housing;
a sound processor disposed inside the housing and communicatively linked with the at least two microphones, the sound processor configured to compare the sound data received at each of the at least two microphones to determine a direction of the tactile motion input; and
a host processor disposed inside the housing and communicatively linked to the sound processor, the host processor configured to control a command of the device based at least in part on the determined direction of the tactile motion input.

2. The device of claim 1, wherein:
the at least two microphones are configured to receive the sound data over a predetermined period of time; and
the sound processor is configured to compare the sound data received at each of the at least two microphones over the predetermined period of time to determine the direction of the tactile motion input by including processing steps of:
processing the sound data received over the predetermined period of time to detect a change in a property of the sound data over the predetermined period of time, and
comparing the change in the property of the sound data over the predetermined period of time.

3. The device of claim 2, wherein the change in the property of the sound data includes a change in intensity of the sound data over the predetermined period of time.

4. The device of claim 2, wherein the change in the property of the sound data includes a change in waveform of the sound data over the predetermined period of time.

5. The device of claim 1, wherein the sound processor is configured to perform background noise cancellation when comparing the sound data received at each of the at least two microphones to determine the direction of the tactile motion input.

6. The device of claim 1, wherein the sound processor is configured to compare the sound data received at each of the at least two microphones independent of a surface texture-based sound model to determine the direction of the tactile motion input.

7. The device of claim 1, wherein the tactile motion input includes scratches to the back surface of the device.

8. The device of claim 1, wherein the device includes a mobile device.

9. The device of claim 8, wherein the mobile device includes a smart phone.

10. The device of claim 1, wherein the at least two microphones include microelectromechanical systems (MEMS) microphones.

11. The device of claim 1, wherein the command of the device controlled by the host device includes a command to navigate a user interface of the device.

12. A method of providing sound-based user interface on a device, the method comprising:
receiving, at each of microphones at different locations within the device, sound data associated with a tactile motion input on an existing surface of the device;
comparing at least one property of the sound data received at each of microphones to determine a direction of the tactile motion input; and
mapping a command on device to the determined direction of the tactile motion input.

13. The method of claim 12, wherein receiving the sound data includes receiving the sound data at a first time point and a second time point.

14. The method of claim 13, including:
determining a change in the at least one property of the sound data received at the first time point and the second time point.

15. The method of claim 12, wherein the at least one property of the sound data includes an intensity of the sound data.

16. The method of claim 12, wherein the at least one property of the sound data includes a waveform of the sound data.

17. The method of claim 12, including performing background noise cancellation when comparing the at least one property of the sound data received at each of the microphones to determine the direction of the tactile motion input.

18. The method of claim 12, wherein comparing the at least one property of the sound data received at each of the microphones is performed independent of a surface texture-based sound model to determine the direction of the tactile motion input.

19. A device for providing sound-based user interface, the device comprising:
a housing including at least front and back surfaces;
microphones disposed inside the housing at different locations, the microphones configured to receive sound data associated with a tactile motion input on one of the at least front and back surfaces of the housing;
a sound processor disposed inside the housing and communicatively linked with the microphones, the sound processor configured to compare at least one property of the sound data received at each of the microphones to determine a direction of the tactile motion input; and
a host processor disposed inside the housing and communicatively linked to the sound processor, the host processor configured to:
operate an application programming interface (API) that maps a command of the device to the determined direction of the tactile motion input and
use the mapped command to control an application running on the device.

20. The device of claim 19, wherein the application running on the device includes a game.
